(19) United States
(12) Patent Application Publication
(10) Pub. No.: US 2020/0191525 A1
(43) Pub. Date: Jun. 18, 2020

(54) Daylight Laser Beam Gun Sight Viewer Method and Apparatus

(71) Applicant: Gregory Hubert Piesinger, Cave Creek, AZ (US)

(72) Inventor: Gregory Hubert Piesinger, Cave Creek, AZ (US)

(21) Appl. No.: 16/221,538

(22) Filed: Dec. 16, 2018

(51) Int. Cl. F41G 3/06; F41G 1/35; F41G 11/00; G02B 5/04

(52) U.S. Cl. CPC F41G 3/065; G02B 5/04; F41G 11/001; F41G 1/35

(57) ABSTRACT

Methods and apparatus are described for extending the visible daylight range of currently available laser gun sights where a small red or green laser diode pointer is mounted on a firearm to indicate the point of bullet impact. Current devices work extremely well in low light conditions but the laser spot is very difficult to see beyond a few yards in bright sunlight since laser power is restricted by federal law. A first method extends daylight range by mounting a laser viewer on the firearm which contains a narrowband optical filter tuned to the laser pointer wavelength. This eliminates all visible daylight except at the narrow filter wavelength. A second method adds a similar narrowband filter to the laser pointer so all regulated power passes through the laser viewer filter. A third method adds a polarization filter to both the laser pointer and laser viewer to reject polarized glare and to effectively increase regulated power by removing polarization energy not used by the laser viewer.

### RELATED INVENTION

The present invention claims priority under 35 U.S.C. § 119(e) to: “Daylight Laser Beam Gun Sight Viewer Method and Apparatus” Provisional U.S. Patent Application Ser. No. 62/607,404, filed 19 Dec. 2017 which is incorporated by reference herein.

### TECHNICAL FIELD OF THE INVENTION

The present invention relates to the field of laser gun sights in which a small red or green laser diode pointer is mounted on a firearm to indicate the point of bullet impact.

### BACKGROUND OF THE INVENTION

Laser gun sights have become very popular recently with many manufacturers offering red and green laser pointers packaged for easy mounting on most popular brands of firearms. These gun sights allow the user to simply point the firearm at the target without the need to first line up the traditional gun sights on the target. Instead, the user simply points the gun mounted laser pointer at the target, and the laser spot indicates the bullet's point of impact on the target.

These devices work extremely well in low light conditions. However, the maximum power output of these laser pointers is restricted by federal law to a maximum power output of 0.005 watts (5 mw). As a result, the laser spot on the target is very difficult to see beyond a range of a few yards in bright sunlight. Therefore, laser gun sights are essentially useless in bright daylight except at very close range (5 to 10 yards).

This patent application discloses methods and apparatus that allow laser gun sights to be used in bright daylight out to ranges on the order of 100 yards.

### SUMMARY OF THE INVENTION

Accordingly, it is an advantage of the present invention that methods and apparatus are disclosed for extending the visible range of currently available laser gun sights.

It is another advantage of the present invention that methods and apparatus are disclosed to modify laser pointers to further extend their visible range.

Three different methods and apparatus are disclosed in the current invention which, individually or together, extend the visible range of laser gun sights.

The first method implements a narrowband optical filter inside a laser viewer which is tuned to the laser pointer wavelength. The laser viewer is mounted on the firearm, through which the shooter views the laser spot on the target. The narrowband filter eliminates all visible daylight except for the laser pointer wavelength, thus approaching conditions available in low light.

The second method adds the same narrowband optical filter to the laser pointer, thus blocking all energy from the laser pointer except for a single narrowband spectrum. Thus, the entire regulated maximum emitted 5 mw laser pointer energy occurs at the narrowband wavelength of the laser viewer narrowband filter.

The third method further reduces daylight interference by adding a polarization filter to both the laser pointer and the laser viewer. This filter acts similar to polarized sunglasses by rejecting polarized glare. It also allows the useful emitted energy of the laser pointer to be further increased by removing the emitted polarized energy not used by the gun mounted laser viewer.

Other objects and advantages of the present invention will become obvious as the preferred embodiments are described and discussed below.

### BRIEF DESCRIPTION OF THE DRAWINGS

FIG. 1 illustrates a typical mounting of the laser beam gun sight viewer on a pistol.

FIG. 2 illustrates a typical implementation of the laser beam gun sight viewer.

### DETAILED DESCRIPTION OF THE PREFERRED EMBODIMENTS

Initially, laser gun sights used red laser diodes at 620-670 nm since green laser diodes didn't yet exist. However, the human eye has evolved to see the color green better than any other color in the light spectrum. Therefore, a green laser appears much brighter in bright sunlight than a red laser. Although the methods and apparatus disclosed in this patent application could apply to either red or green laser gun sights, there is little reason to apply them to red laser gun sights due to the lower eye visibility of red light.

Also, although these methods and apparatus can be applied to both pistols and rifles, they are most applicable to pistols since rifles are typically used for long range shooting and usually incorporate rifle scopes. Therefore this patent disclosure will explain their application to pistols.

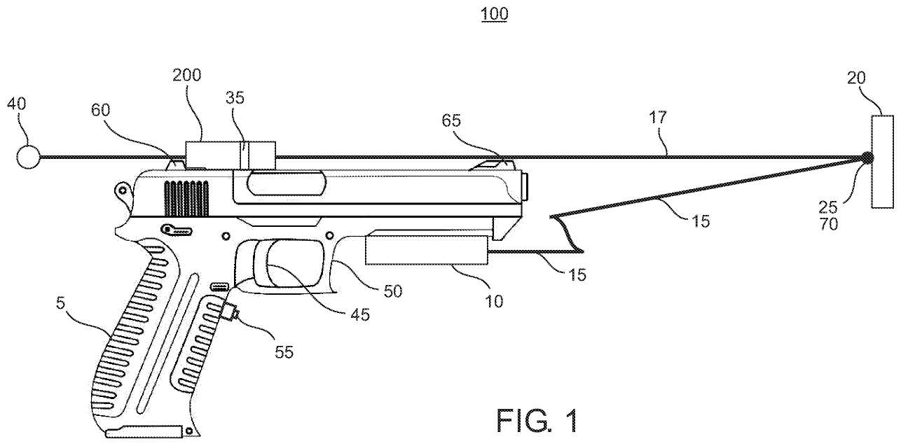

FIG. 1 illustrates an application 100 of laser gun sights on pistol 5. Laser pointer 10 is best attached to the underside of pistol 5, but can also be mounted in a variety of other locations on either the side or top of pistol 5. A push button switch 55 is best placed below trigger guard 50, but can also be mounted in other locations. The shooter presses push button switch 55 to turn on laser pointer 10.

Laser beam 15 from laser pointer 10 strikes target 20 and appears as a small bright circular laser spot 25 on target 20. Reflected laser spot 17 is viewed by shooter eye 40 who adjusts pointing of pistol 5 to place laser spot 25 at the desired position on target 20 prior to pulling trigger 45.

Typically, the position of shooter eye 40 will be lined up so as to sight along the top of pistol 5 towards target 20. However, at close rang in low light conditions, this is not necessary as laser spot 25 is very bright. In bright daylight, laser spot 25 is not visible, so the position of shooter eye 40 must be such so as to place rear sight 60 in line with front sight 65 and desired impact point 70 on target 20.

As shooters age, it becomes more difficult to near focus on rear sight 60 and front sight 65 and still far focus on target 20. This is especially true wearing bifocal glasses. It would be much easier and more accurate if gun sights 60 and 65 could be ignored and simply far focus on target 20. The use of narrowband filter 35 in laser viewer 200 allows this by making laser spot 25 visible in bright daylight.

Laser viewer 200 is best installed just forward of rear sight 60 so it falls in line with the natural position of shooter eye 40 when aligning rear sight 60 with front sight 65 and desired impact point 70 on target 20. That is, the shooter simply views laser spot 25 through laser viewer 200 and then adjusts pointing of pistol 5 to place laser spot 25 at the desired position on target 20 prior to pulling trigger 45.

There are many filter types and bandwidths that could potentially be used for narrowband filter 35. However, experiments have shown that in bright daylight, a filter bandwidth on the order of 10 nm works well with green laser diodes. This bandwidth eliminates enough of the solar spectrum to see laser spot 25, yet is broad enough to still clearly see the surrounding environment in shades of green. For these narrow bandwidths, the most practical filter is a dichroic hard-sputtered bandpass filter which is very thin and has low transmission loss.

Dichroic filters work by reflecting unwanted wavelengths, while transmitting the desired portion of the spectrum. However, unlike absorptive filters, dichroic filters are extremely angle sensitive. Increasing the angle of incidence through a dichroic filter will shift its bandpass towards shorter wavelengths. This is actually a benefit for this application as is explained below.

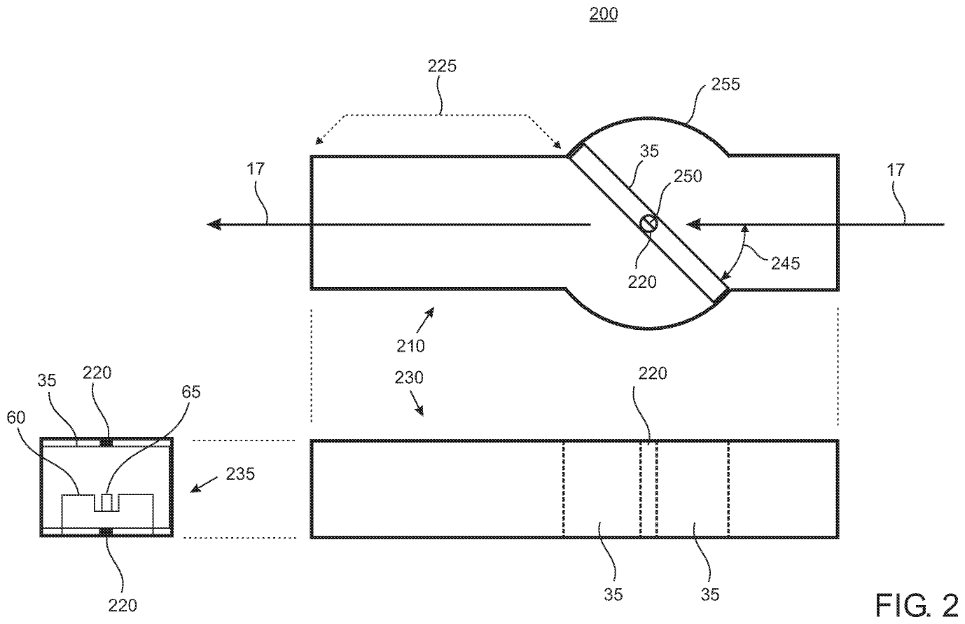

Manufacturers of green laser gun sights indicate the output wavelength is in the range of 515 nm to 532 nm due to a variety of manufacturing tolerances including temperature. Therefore, selecting a fixed 10 nm wide bandwidth at 520 nm, for example, would work perfect if the particular laser pointer emitted at 520 nm but would not work at all if used with another laser pointer that emitted at 530 nm as the narrowband filter would completely eliminate the 530 nm wavelength. Solving this problem using a fixed bandpass filter is illustrated in FIG. 2 where narrowband filter 35 is mounted in laser viewer 200 at an angle with respect to reflected laser spot 17.

Top view 210 of laser viewer 200 illustrates narrowband filter 35 mounted on pivot axis 220 such that angle of incidence 245 between narrowband filter 35 and reflected laser spot 17 can be varied from normal (90 degrees) to around 45 degrees off normal. If the center wavelength of narrowband filter 35 is selected slightly above 532 nm, then as angle of incidence 245 is rotated off normal, the actual center wavelength of narrowband filter 35 will decrease. Therefore, a fixed wavelength narrowband filter 35 can be used at any laser pointer 10 emitted wavelength over its specified range of 515 nm to 532 nm. Screwdriver slot 250 in pivot axis 220 allows shooter to vary angle of incidence 245 to maximize brilliance of laser spot 25 when viewed through laser viewer 200.

As narrowband filter 35 reflects all wavelengths outside its bandwidth, any light entering the shooter (rear) end of laser viewer 200 will be reflected back at the shooter when narrowband filter 35 angle of incidence 245 is normal. That is, in bright sunlight, narrowband filter 35 appears as a mirror to the shooter due to bright daylight entering the rear end of laser viewer 200. This light overwhelms reflected laser spot 17 and the environment view through laser viewer 200. Choosing narrowband filter 35 center wavelength so that angle of incideuce 245 is never normal, reflects any daylight entering the rear end of laser viewer 200 onto shroud 225 instead of into shooter eye 40.

Although the shape of laser viewer 200 housing could be either round, square, or rectangular, the most appropriate shape is rectangular with bulge 255 at narrowband filter 35 location so that narrowband filter 35 still fills the full cross section of laser viewer 200 when angle of incidence 245 is set to its maximum angle away from normal.

Side view 230 illustrates a side view of laser viewer 200 while shooter view 235 illustrates the shooter's view. It is best to keep the vertical dimension of laser viewer 200 as short as possible so as to not add much height to pistol 5. The horizontal dimension of laser viewer 200 can equal the thickness of pistol 5 so as to give the shooter the widest field of view through laser viewer 200. As illustrated in shooter view 235, rear sight 60 and front sight 65 can still be viewed by the shooter through laser viewer 200 to assist in the initial pointing of pistol 5.

The firearms aftermarket sells many types of front and rear sights with various features that consumers can purchase and install in place of the original factory sights. On many small pistols (especially small automatic pistols), the base of the rear sight has a dovetail that slides into a matching dovetail slot near the rear of the pistol slide. For these types of pistols, the optimum laser viewer design is to incorporate a similar rear sight 60 with dovetail as part of laser viewer 200 as illustrated in shooter view 235. In this way, laser viewer 200 can easily be mounted on pistol 100 by sliding out factory rear sight 60 and sliding in laser viewer 200.

A second method of adding additional brilliance to laser spot 25 when viewing through laser viewer 200 is to add a similar narrowband filter to laser pointer 10. Depending on the laser pointer design, this may or may not help much. Green laser diodes operate different from red laser diodes. Red laser diodes generate red laser light directly whereas green laser diodes first create high power light at 808 nm, doubles it to 1064 nm (infrared) in a YAG crystal, and emits half the 1064 nm wavelength as 532 nm green light.

A high quality green laser pointer filters out all the infrared and other spurious wavelengths from the desired green light. However, any spurious wavelengths remaining add to the 5 mw power limit. By adding matching narrowband filters to both laser pointer 10 and laser viewer 200, the full 5 mw power limit consists of green light that will pass through narrowband filter 35.

A third method of adding additional brilliance to laser spot 25 when viewing through laser viewer 200 is to add a vertically polarized filter to both laser pointer 10 and laser viewer 200. When bright daylight strikes a surface, the reflected waves are polarized to match the angle of that surface. So, a highly reflective horizontal surface (such as metal, water, etc.) will produce a lot of horizontally polarized light.

Adding a vertically polarized filter to laser viewer 200 allows only vertically polarized light to enter. This eliminates bright glare from horizontal surfaces.

Adding a vertically polarized filter to laser pointer 10 allows only vertically polarized light to be emitted while filtering out all horizontally polarized laser light. Therefore, the full 5 mw power limit consists of vertically polarized green light which is the only polarization that passes through laser viewer 200. This effectively increases the brilliance of laser spot 25 when viewed through laser viewer 200.

Although the preferred embodiments of the invention have been illustrated and described in detail, it will be readily apparent to those skilled in the art that various modifications may be made therein without departing from the spirit of the invention.

For example, a similar narrowband filter could be implemented on eyeglasses as either bifocals or flip-down. In this way, the shooter could either tilt the head up or down (depending on the location of narrowband filter 35) or flip down narrowband filter 35 similar to flip-down sunglasses. Laser spot 25 brilliance could be maximized by turning the head slightly either left or right to place reflected laser spot 25 at the optimum angle of incidence 245.

1. A method of extending a visible range of laser gun sights in bright daylight, the method comprising:
mounting a laser pointer whose output wavelength is in a range of 515 nm to 532 nm on a firearm;
mounting a laser viewer on the firearm;
mounting an optical filter on a pivot axis inside the laser viewer, the optical filter selected as an angle of incidence sensitive dichroic hard-sputtered narrow bandpass filter whose bandwidth is approximately 10 nm;
allowing the angle of incidence between the laser pointer reflected light and the optical filter to be varied from normal to around 45 degrees off normal;
choosing a center wavelength of the optical filter so the angle of incidence is never normal at the laser pointer output wavelength;
incorporating a shroud of sufficient length between the optical filter and rear end of the laser viewer to reflect daylight entering the rear end of the laser viewer onto the shroud instead of into a shooter's eye;
viewing through the laser viewer a laser pointer spot reflected from a target, the laser pointer spot indicating a point of impact of a bullet on the target; and
adjusting the angle of incidence of the optical filter to maximize intensity of the laser pointer spot reflected from the target.

2-5. (canceled)

6. The method as claimed in claim 1 wherein the laser viewer contains a bulge located adjacent to the optical filter such that the optical filter fills a full cross section of the laser viewer for all settings of the angle of incidence.

7. (canceled)

8. The method as claimed in claim 1 wherein a width and a height of the laser viewer will enable a shooter to view a rear and a front sight of the firearm.

9. The method as claimed in claim 1 wherein:
the laser viewer further comprises an internal rear sight, the rear sight configured to appear similar to a firearm rear sight;
the laser viewer further comprises a dovetail mount, the dovetail mount placed on bottom of the laser viewer, and the dovetail mount configured to fit into the firearm rear sight mounting groove;
removing the firearm rear sight from the firearm rear sight mounting groove; and
mounting the laser viewer onto the firearm by sliding the dovetail mount on the laser viewer into the firearm rear sight mounting groove.

10-11. (canceled)

12. The method as claimed in claim 1 wherein the laser viewer is mounted forward of a rear sight of the firearm so the laser viewer falls in line with a shooter's eye when aligning the rear sight with a front sight and a desired impact point on the target.

13-19. (canceled)

20. A method of extending the visible range in bright daylight of a laser gun sight mounted on a firearm, said method comprising:
mounting a laser viewer on said firearm;
mounting a narrowband optical filter inside said laser viewer;
selecting said narrowband optical filter center wavelength to match said laser gun sight laser wavelength;
selecting said narrowband optical filter bandwidth as approximately 10 nm to eliminate most daylight solar spectrum yet still clearly see the surrounding environment; and
viewing reflected laser spot from said laser gun sight on target through said laser viewer to indicate bullet's point of impact on said target.

21. (canceled)
